(19) United States
(12) Patent Application Publication
(10) Pub. No.: US 2025/0073733 A1
(43) Pub. Date: Mar. 6, 2025

(54) SPRAY PROCESS CALIBRATION TARGET OF A COATING PRODUCTION LINE SYSTEM

(71) Applicant: coatingAI AG, Winterthur (CH)

(72) Inventor: Marlon BOLDRINI, Zürich (CH)

(73) Assignee: coatingAI AG, Winterthur (CH)

(21) Appl. No.: 18/826,447

(22) Filed: Sep. 6, 2024

(30) Foreign Application Priority Data
Sep. 6, 2023 (EP) 23195815.8

(51) Int. Cl. B05B 12/08; B05B 12/16

(52) U.S. Cl. CPC B05B 12/084; B05B 12/16

(57) ABSTRACT

A spray process calibration target (10) of a coating production line system for coating work pieces comprises a plurality of target detection areas (12) positioned around a central target detection area (62); a plurality of connecting webs (13, 13′, 13″); and at least one attachment means (11, 14, 62″); wherein each of the plurality of target detection areas (12) is connected via at least one of the plurality of connecting webs (13, 13′, 13″) directly or via one or more of further target detection areas (12) to at least one attachment means (11, 14, 62″) allowing to obtain coatings on the plurality of target detection areas (12) for calibration of a spray nozzle directed onto the central target detection area (62).

### TECHNICAL FIELD

The present invention relates to a spray process calibration target of a coating production line system for coating work pieces and the coating production line system.

### PRIOR ART

Coating in large-scale manufacturing industry is automatic. The automatic coating production line includes a conveying unit and a coating unit. A baking or drying unit can be provided depending on the coating material to be sprayed for faster drying of the coated work piece. Environmental and safety requirements usually require the presence of a dust removing and exhaust unit. The conveying mechanism runs through the entire automatic coating production line, and the work piece to be coated is inserted in the automatic coating production line, optionally cleaned by the dust removing unit, and then coated in a dedicated coating space or room. After entering the baking unit for drying, and then outputting through the conveying mechanism, the industrial waste gas containing the dust and mist coating exhaust gas is usually discharged through the exhaust unit.

Spray coating of a work piece with powder or liquid materials by thermal spraying necessitates a thorough knowledge of the spatial material or droplet distribution to provide objective quality criteria for the process control. Therefore, systems and methods are used in the prior art to learn about the spraying characteristics of nozzles used in the process and to calibrate the underlying spraying system.

U.S. Pat. No. 9,931,658 B2 discloses a system for determining process parameters for the spray application of viscous fluids, comprising: an application system for spraying an impacted object with a viscous fluid, the application system being configured to be actuated by predefining a set of input parameters and comprising a metering device, a fluid valve, and an application nozzle, wherein a dynamic behavior of the application system with respect to a volume flow profile of the viscous fluid during application is dependent on predefinable control process parameters; wherein the measurement is effected via a balance for continuously determining a weight of the impacted object, including the viscous fluid applied to the impacted object, and for generating a weight profile in the form of continuous measurement data from the balance. The impacted object is the target used for calibration purposes.

U.S. Pat. No. 8,154,711 B discloses a method to measure a spray pattern using a detection apparatus including at least a light source, a processing unit, and a detector comprising the steps of (a) determining a pattern having a symmetrical distribution representing the desired spray distribution that is used as reference pattern; (b) obtaining a spray pattern; (c) comparing the spray pattern with the reference pattern to detect deviations between the spray pattern and the reference pattern; and (d) evaluating the deviations in terms of size and/or location. The spray pattern is detected on a detection area through scattered light. A substrate position of a work piece to be coated is projected into the detection area.

WO 2018/042399 A1 discloses a plant to enamel sanitary fixtures; the plant comprising application means, which are provided with at least one enameling spray emission nozzle for the emission of an enameling spray, and detection means to detect at least one feature of the morphology of the sprays produced by said emission nozzle. This detection means comprises a laser light generator and a video camera, which is designed to receive images of at least one cross section lit by the laser light on said enamel spray, as well as means for reprocessing image data captured by said at least one video camera.

These two latter mentioned methods use virtual targets and determine the material distribution via projection of a substrate into the position of a detection area.

### SUMMARY OF THE INVENTION

Based on the known art it is an object of the invention to provide a coating production line system which can be more readily calibrated avoiding any weight target method as well as virtual target methods which necessitate to include the necessary measurement means in the production line system. The mentioned object for improving the coating calibration process is achieved by providing a spray process calibration target characterized by the features of claim 1.

This target can be readily introduced in any existing production line system, since the calibration check is conducted outside of the production line system.

The invention is based on the insight that it is necessary to calibrate the one or more nozzles of a coating production line system. Therefore, the distribution of the sprayed coating has to be evaluated up front the use of the system. The industrial target of the coating process is a full plate surface which might by curved but which is, to the extent of the spraying image of the nozzle, almost a plan surface. Therefore, the calibration plate according to the invention also uses a plate, especially a flat target plate. If a full plate is used to be coated as a target for evaluation, the result is not satisfactory, since the spray pressure onto the plate will influence the spray result. The gas sprayed with the powder increases the gas pressure in front of the target and thus distorts the coating result. This happens, because in the case of use the nozzle is moved over the surface and the effect of the raising gas pressure in front of the surface to be coated does not happen to an extent falsifying the result of the calibration.

Coating layers accumulate to a balance, reflecting the interplay between the attracting forces between the coatings and the workpiece and the shear stress resulting from the airflow. When statically spraying onto a flat surface as a target for evaluating the distribution, this equilibrium becomes distorted and fails to represent the real-world scenario where spray guns are in motion. Within the region where the spray cone contacts the surface, a pressure zone is created, diverting the airflow and consequently causing very low shear stress in that area. As a result, the accumulation of coating material in this region is disproportionately higher than what it would be under normal operating conditions. The innovative calibration target described herein additionally substantially mitigates this issue, as the airflow is able to traverse the unoccupied areas, allowing for a more accurate representation of the coating process.

A spray process calibration target according to the invention to be used in a coating production line system for coating work pieces comprises:
a plurality of target detection areas positioned around a central target detection area;
a plurality of connecting webs; and
at least one attachment means;

wherein each of the plurality of target detection areas is connected via at least one of the plurality of connecting webs directly or via one or more of further target detection areas to at least one attachment means.

Provision of a plurality of target detection areas with throughgoing areas provide a ratio of coatable surface to throughgoing areas avoiding an distorted or tainted spray image for calibration of the nozzle since the small detection areas do not create a stagnation pressure as if when the spray coating material is directed on a full surface target.

The different target detection areas can have a shape from the group comprising a circular, hexagonal, square, polygonal or ellipsoid shape. All shapes of the plurality of shapes can have the same shape or different shapes or orientations (for the ellipsoid shape and in view of the orientation of the corners of polygons).

The plurality of target detection areas can be arranged in a rectangular grid, wherein each target detection area is connected via at least one connecting web with at least one of the adjacent target detection areas, either horizontally, vertically and/or diagonally. Therefore, one target detection area can have up to eight connecting webs, although a more limited number is preferred, usually two or three connecting webs for each target detection area are providing a stiff grid structure.

The grid will usually have m times n target detection areas, wherein m and n are integers between 5 and 9. They are preferably odd integers to have a predetermined central detection area.

The ratio of the sum of the surface of the plurality of target detection areas (i.e. the area which receives sprayed content from the nozzle and build up a coating) to the surface of the throughgoing areas between the target detection areas (i.e. the area where the pressure of the is between 2% and 50%, preferably between 6.5% and 35%, more preferred between 12.5% and 25%. The surface of the plurality of target detection areas is defined as the sum of all individual target detection areas delimited by the physical outline of the border positioned target detection areas, usually delimited by the four detection areas in the corner of the grid.

Usually, the ratio of the target area radius or apothem to web length is between 10% and 200%, preferably between 20% and 100%, more preferred between 33% and 66%. The web length is here defined to be the horizontal or vertical (not diagonally) connecting web length between two adjacent target areas without blank spaces.

The connecting webs have in a view from above (which is the main spray direction of a nozzle oriented towards the target) on the target a shape of a plus sign (=“+”) or a T shape with the horizontal portion of the T in the plane of the target to strengthen small width webs.

Such a spray process calibration target can have specific different attachment means like one or more flaps configured to be attached to the conveyor unit of the coating production line system for coating work pieces or the attachment means is simply one or more of border positioned target detection areas.

Coating production line system for coating work pieces comprises a coating apparatus configured to provide a coating for the work pieces based on a coating powder or liquid with at least one nozzle; an inspection unit configured to measure the thickness of a coating applied to the work pieces; a conveyor unit configured to move the work pieces through the coating apparatus and the inspection unit in this order; and a control unit connected for data transmission with the inspection unit, the coating apparatus and the conveyor unit; wherein a spray process calibration target according to any one of the preceding claims is attached to the conveyor unit for being centrally spayed by one of the one or more nozzles for generating a calibration spray coating image of the said nozzle.

Further embodiments of the invention are laid down in the dependent claims.

### BRIEF DESCRIPTION OF THE DRAWINGS

Preferred embodiments of the invention are described in the following with reference to the drawings, which are for the purpose of illustrating the present preferred embodiments of the invention and not for the purpose of limiting the same. In the drawings,

FIG. 1 shows a schematical view of a spray process calibration target of a coating production line system according to a first embodiment of the invention;

FIG. 2 shows a schematical view of a spray process calibration target of a coating production line system according to a second embodiment of the invention;

FIG. 3 shows a schematical view of a spray process calibration target of a coating production line system according to a third embodiment of the invention;

FIG. 4 shows a schematical view of a spray process calibration target of a coating production line system according to a fourth embodiment of the invention; and

FIG. 5 shows a schematical view of a spray process calibration target of a coating production line system according to a fifth embodiment of the invention.

### DESCRIPTION OF PREFERRED EMBODIMENTS

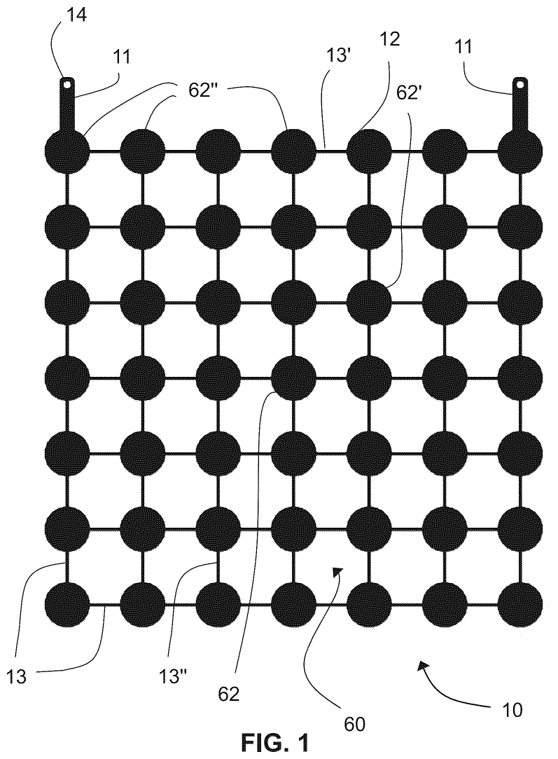

FIG. 1 shows a schematical view of a spray process calibration target 10 of a coating production line system according to an embodiment of the invention.

A calibration plate is positioned as a calibration target 10 in front of the spray gun, the distance therebetween corresponding to the distance between the spray gun and the workpiece during production. The spray gun is then activated, and a static spray is applied to the calibration plate for a predetermined time interval. The time for activating the spray must be set in such a manner that a sufficient buildup of material occurs on the calibration plate without reaching a saturation point in any region. For powder coatings, the resulting maximum thickness should fall within a range of approximately 100 micrometers.

Measurements of the resultant layer thickness are obtained at designated measurement points. Based on these measurements and the known distance between the points, a generalized Gaussian function is fitted to the points to characterize the layer thickness distribution on the target.

The spray process calibration target 10 comprises a plurality of detection areas. Here, these are 7 times 7 equal to 49 detection areas. The detection areas of the target 10 of FIG. 1 are circular target detection areas 12. The circular target detection areas 12 are plate-shaped detection areas, especially flat or plan plate portions. The circular target detection areas 12 are interconnected with connecting webs 13. Here are provided horizontal webs 13′ as well as vertical webs 13″ connecting each circular target detection area 12 with its two, three of four neighbors. The grid of circular target detection areas 12 comprises attachments or fixation means. These attachments are in the embodiment of FIG. 1 integrated attachment flaps 11 with holes 14 to hang the target in an automatic coating production line 10 as a usual workpiece on a conveying mechanism running through the entire automatic coating production line, and the target 10 to be coated is inserted in the automatic coating production line. The attachments can also be holes in the uppermost left and right target areas or the attachments can be hooks connected to such target areas.

Here, there are two attachment flaps 11 provided at the outmost exterior detection areas 62″ in the upper corners. It is of course possible to provide these attachment means at other detection areas 62″ or providing further connecting webs leading to these attachment means. Usually, the target 10 is hanging in a way that the webs 13 as indicated above are horizontally oriented webs 13′ and vertically oriented webs 13″. The spray nozzle of the automatic coating production line is then positioned in the spray coating position of the target 10 in front of the central target detection area 62, wherein the main spraying direction of the spray nozzle is vertical to the drawing plane.

It is also possible to omit specific attachments means as flaps if the automatic coating production line is configured to clamp the target 10 or hold it e.g. through transpiercing one or more exterior target detection areas 62″ for maintaining them. In this case, the free end of the connecting web providing the attachment position or the exterior target detection area 62″ is defined in the framework of the present invention as attachment means.

It is preferred that the target 10 is positioned in this way symmetrical to the main spraying direction to obtain a good spraying image distribution having usually the highest coating value at the central target detection area 62 and then reduced coating values in the surrounding target detection areas 12.

The distance between two adjacent target detection areas 12 (in the horizontal and vertical direction) is determined by the radii of the different target detection areas 12 as well as the length of the interconnecting webs 13 being either webs 13′ or webs 13″. In the embodiment of FIG. 1 the radius of all target detection areas 12 is identical and is approximately ⅔ (66%) of the length of the interconnecting webs 13. Therefore, the target 10 comprises beside the target detection areas 12 and the webs the throughgoing areas 60 which are building a through plane in the panel and form holes in it. The ratio of the target areas 12 receiving sprayed materials to the throughgoing areas 60 is then about 25%, i.e. the free flow of the spray coating can go through the areas 60 for about ¾ of the entire spray volume and the remaining 25% are distributed on the different target detection areas 12 with different coating thicknesses depending on the distance from the central target area 62. The calculation was executed based on circular target detection areas 12 and a higher number of target detection areas in the grid since the coverage is especially important in and around the central area of the target, where the highest pressure of an incoming spraying material is experienced. Rectangular detection areas with a side length of the double radius would give a coverage of about 33%.

With different radii of the target detection areas 12 and different distances between the borders of the target detection areas 12 defining the length of the connecting webs 13 different proportions of coverage of the total area by the target detection areas 12 are created. For this is sufficient to know the ratio between web length and radius of the target detection area 12 for a given shape of the target detection areas 12.

| ratio target area radius to web length | covered area |
|---|---|
| 20% | 6.5% |
| 33% | 12.5% |
| 50% | 20% |
| 66% | 25% |
| 100% | 35% |
| 200% | 50% |

It is also possible to go below the shown 20%, e.g. 10% which reduces the usable target detection area for measuring the coating thickness to about 2%, or beyond 100% as up to 200% which provides 50% through going areas 60. Preferred ratios are between 20% and 100%, more preferred between 33% and 66%.

It is possible, although not shown in the drawings, different target detection areas 12 can have different radii. It is possible that the radius of the target detection areas 12 increases with distance from the center area 62, e.g. the target areas 12 in one connecting web distance have a +20% radius, the target areas 12 in two connecting web distance have a +40% radius and the target areas 12 in three connecting web distance have a +60% radius. Of course, the differences of area increase can be chosen smaller or greater. The advantage for this increase of target area surface for the outer target areas is to allow a better evaluation of the coating thickness in the case of a nozzle with a very centric spraying characteristic, leaving less material away from the center area 62.

The usual dimensions of such targets as shown in FIG. 1 are between 10×10 centimeter to 30×30 centimeter with target areas between 10 millimeter to 30 millimeter diameter, i.e. usual radii are e.g. 10 millimeter with a similar rectangular target having target side length of 20 millimeter. In order to avoid edge effects when the pressure of the coating spray hits the circumference of a target area, it is better to have greater radii as 10 to 15 millimeter.

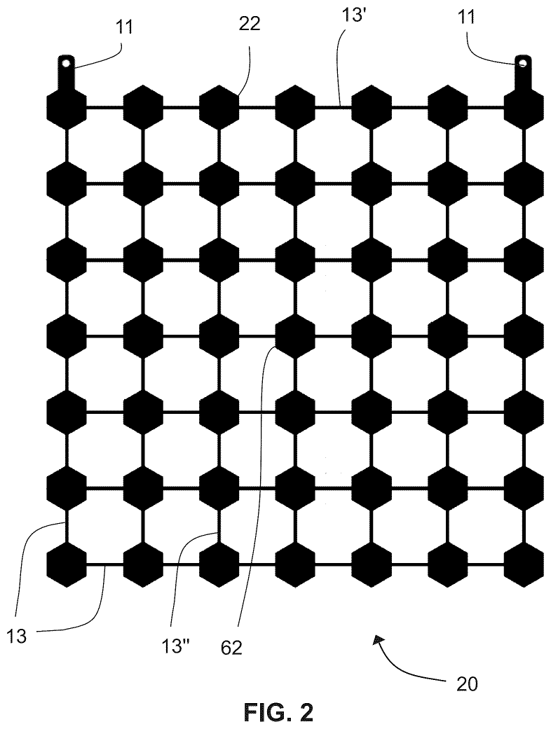

FIG. 2 shows a schematical view of a spray process calibration target 20 of a coating production line system according to an embodiment of the invention. All features identical to all embodiments receive identical reference numerals, similar features receive similar reference numerals.

The spray process calibration target 20 comprises a plurality of detection areas. Here, these are 7 times 7 equal to 49 detection areas. The detection areas of the target 20 of FIG. 2 are hexagonal target detection areas 22. The hexagonal target detection areas 22 are interconnected with connecting webs 13 as in the case of the embodiment of FIG. 1. The disclosure in view of the embodiment of FIG. 1 relating to the attachment means 11, the possibility of adaption of the ratio web length to the “radius” as well as a size development of the target areas in a distance from the center area 62 apply to the embodiment of FIG. 2. One difference is of course the concept of a “radius” which is called apothem. For a hexagon, the surface of the target area 22 is about 10% larger than the target area 12 for a circle where the radius of the circle has an identical value as the apothem of the hexagon. Therefore, the above table from FIG. 1 of ratios for different web lengths to radii also apply here, when radii are simply replaced by apothema.

It is clear that other polygons as target areas can be chosen as e.g. squares and other forms as ellipses etc. It is also possible to combine different target area forms, e.g. 12 and 22 in one target.

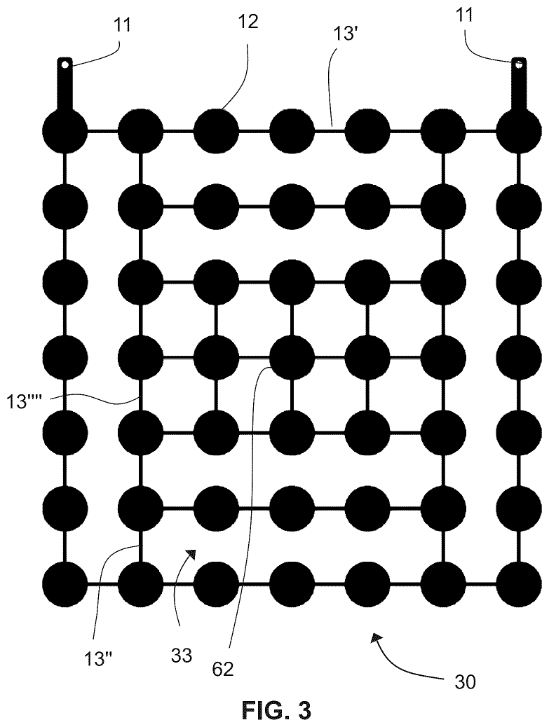

FIG. 3 shows a schematical view of a spray process calibration target 30 of a coating production line system according to an embodiment of the invention. The difference of the embodiment of FIG. 3 over FIGS. 1 and 2 is the omission of connecting webs, here creating the omitted connection web areas 33 at various places of the target 30. In fact, a number of connecting webs can be omitted. Here, the reference numeral 13″″ designates a removable connection web and there are more without reducing the stability of the target 30. It is preferred that there are more or less direct connections to the central target detection area 62 since the spray pressure of the nozzle to be calibrated is usually strongest there.

It is clear that the omission of webs can be applied independent from the shape of the target area 12, being circular, hexagonal or square etc.

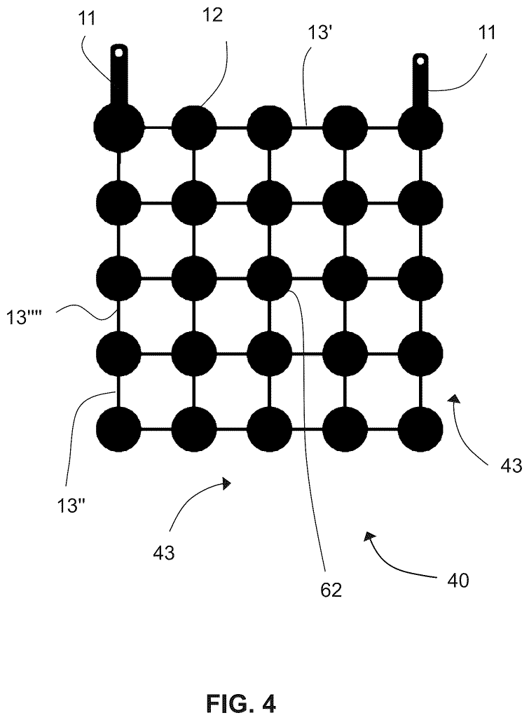

FIG. 4 shows a schematical view of a spray process calibration target 40 of a coating production line system according to an embodiment of the invention. The difference of the embodiment of FIG. 4 over FIG. 1 is the number of target areas. Here, these are 5 times 5 equal to 25 detection areas around a central area 62. The detection areas of the target 40 of FIG. 4 are circular target detection areas 12 but can as mentioned above also have different shapes and sizes as well as different connecting web lengths. The circular target detection areas 12 are interconnected with connecting webs 13 similar to FIG. 1. Such a smaller target 49 can be used in case of a more centric spraying nozzle, where the deposited coating in a distance of three target area distance from the center 62 is negligible. Of course, all features of embodiments mentioned and shown in FIGS. 2 and 3 can also be applied to the smaller target 40.

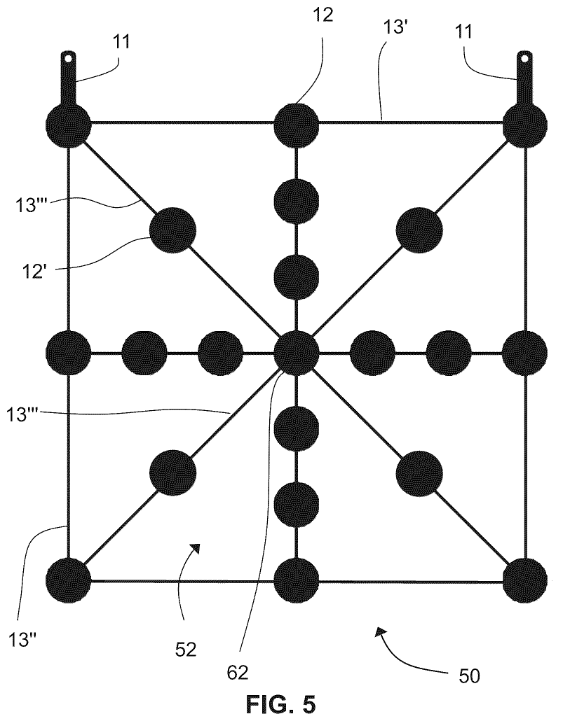

Finally, FIG. 5 shows a schematical view of a spray process calibration target 50 of a coating production line system according to an embodiment of the invention. The difference of the embodiment of FIG. 5 over FIG. 1 in application of the embodiment of FIG. 3 is the distribution of target areas 12. Here, there is provided a 7 times 7 grid in the two directions horizontal and vertical vis-à-vis the central target area 62 with three target areas on each side as well as with four target areas in the corners of the target 50, but there is only one target area as a diagonally connected detection area 12′ between the central area 62 and the target area in the corner. These four diagonally connected detection areas 12′ are connected with diagonal webs 13′″ to said corner and central web. Therefore, they are positioned in view of the horizontally and vertically positioned target areas 12 between the first and the second target area in view of the central area 62. It is of course also possible to provide two diagonally connected detection areas 12′ on each diagonal.

One difference between the embodiment of FIG. 5 and the embodiments of FIGS. 1 to 4 is that the number of target areas is reduced creating omitted target areas 52, here only between the diagonally connected detection areas 12′ and the target areas provided as shown in FIGS. 1 to 4. But it is also possible in FIGS. 1 to 4 to omit one or more non central target areas 12 especially the first diagonally positioned target area 62′ (see FIG. 1) or the second diagonally positioned target area.

The target areas of the target 50 of FIG. 5 are circular target detection areas 12, 12′ but can as mentioned above also have different shapes and sizes as well as different connecting web lengths. The circular target detection areas 12 are interconnected with connecting webs 13 similar to FIG. 1. Of course, all features of embodiments mentioned and shown in FIGS. 2 and 3 can also be applied to this target 50. The connecting webs do not have necessarily perpendicular directions one to the other. The diagonally connected detection areas 12′ can be connected to one of the intermediate target areas 12 on the vertical and horizontal axis. It is just necessary to have enough connecting webs 13 to ensure the stability of the target. It is also possible to have specific target areas only to be connected via one connecting web. The width of the connecting webs can be as small as 10% of the radius of the target area. They can be strengthened by providing them—in a cross-section view—as T-shaped webs, wherein the upper horizontal part of the T is what is seen in the FIG. 1 to 5. The webs can also be of the shape of a plus sign (“+”) since the coating effect on the webs is disregarded. The form above the plane of the flat target areas 12 can also be a small triangle in cross-section to better deflect the impacting spraying. In other words, the web can be just a flat longitudinal strip, a +-sign (or cross) in cross-section, a T shape with the horizontal portion of the T in the plane of the target or a triangular shape with a horizontal portion of the triangular shape in the plane of the target and the upper corner of the triangular shape perpendicularly directed towards the intended position of the nozzle during spraying.

### LIST OF REFERENCE SIGNS

10 target
11 attachment flap
12 circular target detection area
12′ diagonally connected detection area
13 connecting web
13′ horizontal web
13″ vertical web
13′″ diagonal web
13″″ removable connection web
14 attachment hole
20 target
22 hexagonal target detection area
30 target
33 omitted connection web area
43 area around target 40
40 target
50 target
52 omitted target area
60 throughgoing area
62 central target detection area
62′ diagonally positioned target detection area
62″ border positioned target detection area

1. Spray process calibration target of a coating production line system for coating work pieces comprising:
a central plate-shaped target detection area;
a plurality of plate-shaped target detection areas;
a plurality of connecting webs; and
at least one attachment or mounting;
wherein the central plate-shaped target detection area is positioned in a plane, wherein the plate-shaped target detection areas of the plurality of plate-shaped target detection areas are positioned around the central plate-shaped target detection area in the same plane;
wherein each of the plurality of plate-shaped target detection areas is connected via at least one of the plurality of connecting webs directly or via one or more of the plate-shaped target detection areas to at least one attachment or mounting.

2. Spray process calibration target according to claim 1, wherein each of the plurality of plate-shaped target detection areas has a shape from the group comprising a circular, hexagonal, square, polygonal or ellipsoid shape.

3. Spray process calibration target according to claim 1, wherein the plurality of plate-shaped target detection areas is arranged in a rectangular grid, wherein each plate-shaped target detection area is connected via at least one connecting web with at least one of the adjacent plate-shaped target detection areas.

4. Spray process calibration target according to claim 3, wherein the grid has m times n target detection areas, wherein m and n are integers between 5 and 9.

5. Spray process calibration target according to claim 4, wherein m and n are both odd integers.

6. Spray process calibration target according to claim 1, wherein the plate-to-non-plate surface ratio of the sum of the surfaces of the plurality of plate-shaped target detection areas to the sum of the surfaces of the throughgoing areas between the target detection areas is between 2% and 50%.

7. Spray process calibration target according to claim 1, wherein ratio, preferably between 6.5% and 35%, more preferred between 12.5% and 25%.

8. Spray process calibration target according to claim 1, wherein the ratio of the target area radius or apothem to web length is between 10% and 200%.

9. Spray process calibration target according to claim 8, wherein the ratio of the target area radius or apothem to web length is between 20% and 100%.

10. Spray process calibration target according to claim 9, wherein the ratio of the target area radius or apothem to web length is between 33% and 66%.

11. Spray process calibration target according to claim 1, wherein the connecting webs have, in a cross sectional view through the plane of the plate a shape taken from the group encompassing a rectangle, a plus sign with the horizontal portion of the plus sign in the plane of the target, a T shape with the horizontal portion of the T in the plane of the target or a triangular shape with a horizontal portion of the triangular shape in the plane of the target and the upper corner of the triangular shape perpendicularly directed towards the intended position of the nozzle during spraying.

12. Spray process calibration target according to claim 1, wherein the attachment or mounting comprises a flap or hook configured to be attached to the conveyor unit of the coating production line system for coating work pieces, or the attachment or mounting is one or more of border positioned target detection areas.

13. Coating production line system for coating work pieces comprising:
a coating apparatus configured to provide a coating for the work pieces based on a coating powder or liquid with at least one nozzle;
an inspection unit configured to measure the thickness of a coating applied to the work pieces;
a conveyor unit configured to move the work pieces through the coating apparatus and the inspection unit in this order;
a control unit connected for data transmission with the inspection unit, the coating apparatus and the conveyor unit; and
a spray process calibration target comprising:
a central plate-shaped target detection area;
a plurality of plate-shaped target detection areas;
a plurality of connecting webs; and
at least one attachment or mounting;
wherein the central plate-shaped target detection area is positioned in a plane, wherein the plate-shaped target detection areas of the plurality of plate-shaped target detection areas are positioned around the central plate-shaped target detection area in the same plane;
wherein each of the plurality of plate-shaped target detection areas is connected via at least one of the plurality of connecting webs directly or via one or more of the plate-shaped target detection areas to at least one attachment or mounting, and
wherein the spray process calibration target is attached to the conveyor unit configured to be centrally spayed by one of the one or more nozzles onto the central plate-shaped target detection area for generating a calibration spray coating image of the said nozzle.
